(19) United States
(12) Patent Application Publication
(10) Pub. No.: US 2015/0304251 A1
(43) Pub. Date: Oct. 22, 2015

(54) Direct Manipulation of Object Size in User Interface

(71) Applicant: Tictoc Planet, Inc., San Francisco, CA (US)

(72) Inventors: Marc B.D. Greenberg, Oakland, CA (US); Mintak Son, San Francisco, CA (US); Jinhwa Jang, Seongnam-si (KR); Heeyong Kim, Seongnam-si (KR)

(73) Assignee: Tictoc Planet, Inc., San Francisco, CA (US)

(21) Appl. No.: 14/255,868

(22) Filed: Apr. 17, 2014

(51) Int. Cl. H04L 12/58; G06F 3/0488; G06F 3/0484

(52) U.S. Cl. CPC H04L 51/046; G06F 3/04847; G06F 3/04883

(57) ABSTRACT

A client device displays user interface elements on a display device such as a screen. The user interface elements have a configuration including a size. An input device of the client device detects a gesture motion intended to modify the size of a subset of the user interface elements in a composing region of the screen. The gesture motion includes at least one gesture object (e.g., a finger, a stylus) contacting the composing region of the screen, moving across the screen while maintaining contact with the screen, and detaching from the screen after moving across the screen. In response to the gesture motion, the client device determines an updated configuration including an updated size for the subset of user interface elements. The subset of user interface elements is displayed in their updated configuration.

### BACKGROUND OF THE INVENTION

1. Field of the Invention

This disclosure relates generally to user interfaces of computing device applications, and more particularly to manipulating configuration of user interface elements.

2. Description of the Related Art

Mobile devices often include an interface for composing, sending, and receiving textual messages. These interfaces are typically designed to send messages through the Short Message Service (SMS) protocol, which sends textual messages in standardized data packets. The SMS protocol allocates 1120 bits to the text content of a message, so the message may contain between 70 and 160 characters depending on the alphabet used. This compact data transfer protocol does not include metadata for formatting the enclosed text or allow for images or other media. Due to the constraints of SMS, texting interfaces typically provide limited composition functionality limited mainly to inputting letters, numerals, and punctuation. More recently, upgrades to wireless communications infrastructure have enabled message transfer through more verbose protocols than SMS. For example, these protocols support a broader range of characters (e.g., emoticons, emojis) and may also support media messages (e.g., Multimedia Messaging Service, device-specific protocols). Nonetheless, textual message interfaces on mobile devices maintain much of the same limited functionality from their SMS-influenced origin.

### SUMMARY

Embodiments relate to directly manipulating the configuration, including size, of user interface elements in a composer interface. The interface receives message content (or other user interface elements) and displays the received message elements in a first configuration at a first size in a composing region of the interface. A gesture motion on a display is detected by an input device, and a second configuration is determined for a subset of message elements based. on the first configuration and based on the gesture motion. The gesture motion includes at least one gesture object (e.g., a finger, a stylus) contacting the composing region of the display, moving across the display while in contact with the display, and detaching from the display after moving across the display. The composer interface displays the subset of message elements in their second configuration, which may include a second size.

In one embodiment, the composer interface is implemented on a client device. The client device includes a memory for storing instructions for the composer interface; additionally, the client device includes a processor for executing the instructions for the composer interface. The composer interface may also include a display device for displaying the composer interface and an input device for receiving gesture motions and input message content (or other user interface elements). The client device may also include a network interface device for transmitting (e.g., sending and/or receiving messages.

In one embodiment, the composer interface encodes message content and the determined configuration into a message and transmits the message to an additional client device, which can decode the message content and determined configuration from the transmitted message. The additional client device is configured to display message content based on the determined configuration.

In one embodiment, gesture motions to manipulate size include stretch, pinch, rotation, swipe, and scroll gesture motions. The client device may resolve the gesture to include a start position and an end position and determine an updated configuration based on the difference between the gesture's start position and end position. Different gesture motions may be used to increase or decrease the size of the user interface elements relative to the current size of user interface elements.

In one embodiment, the subset of user interface elements is selected prior to the gesture motion using an additional gesture motion. This additional gesture motion includes contacting, with at least one gesture object, a first portion of the screen displaying a starting point of the subset of the user interface elements. Next, the additional gesture includes moving the at least one gesture object from the first portion of the screen to a second portion of the screen displaying an ending point of the subset of the user interface elements. Lastly, the additional gesture concludes by detaching the at least one gesture object from the second portion of the screen.

### BRIEF DESCRIPTION OF THE DRAWINGS

The teachings of the embodiments can be readily understood by considering the following detailed description in conjunction with the accompanying drawings.

FIG. 1 is a block diagram illustrating an environment for communicating between client devices, according to an embodiment.

FIG. 2A is a block diagram illustrating components of an example client device, according to an embodiment.

FIG. 2B is a block diagram illustrating modules on a memory of the client device, according to an embodiment. FIG. 3A and FIG. 3B illustrate an example composer interface for manipulating font size in messages exchanged between client devices, according to an embodiment.

FIG. 4A, FIG. 4B, and FIG. 4C illustrate an alternative method for manipulating font size in an example composer interface, according to an embodiment.

FIG. 5 is a flow chart illustrating an example process for manipulating font size in messages exchanged between client devices, according to an embodiment.

### DETAILED DESCRIPTION OF THE PREFERRED EMBODIMENTS

The figures and the following description relate to preferred embodiments by way of illustration only. It should be noted that from the following discussion, alternative embodiments of the structures and methods disclosed herein will be readily recognized as viable alternatives that may be employed without departing from the principles of the disclosure.

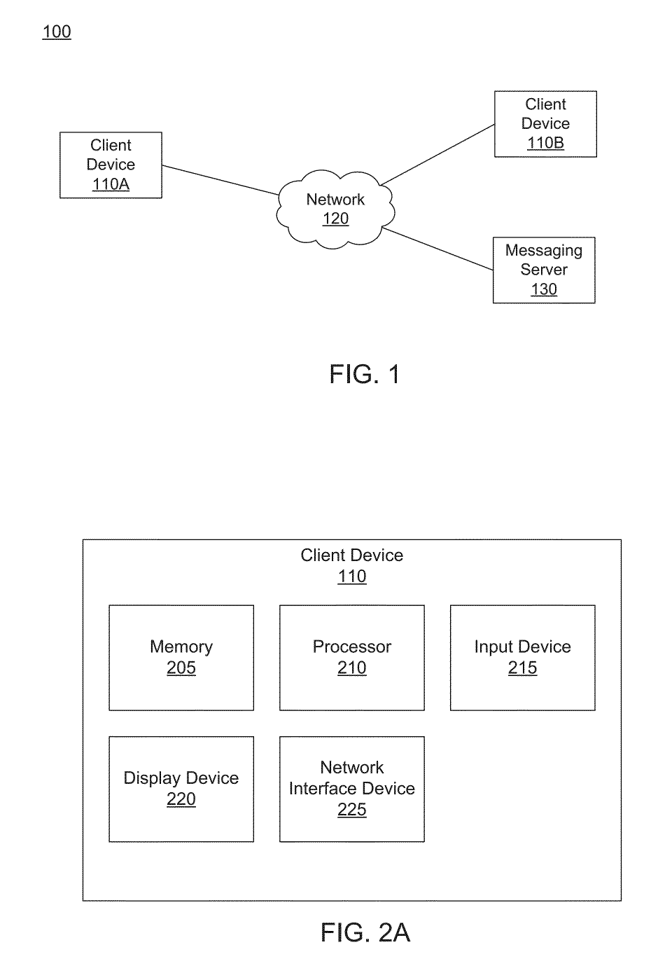

FIG. 1 is a block diagram illustrating an environment 100 for communicating between client devices, according to an embodiment. The environment 100 includes entities such as client devices 110A and 110B, a network 120, and a messaging server 130. Users compose, send, and view messages using their client devices 110A and 110B. The environment 100 may include additional client devices (e.g., exchanging messages among a group). The client devices 110A and 110B may optionally include functionality for encrypting sent messages and decrypting received messages.

The client devices 110A and 110B may be mobile devices (e.g., smartphones, smart watches, wearable devices) or tablets, but they may also be other computing devices (e.g., a laptop, a desktop, a smart television).

In one embodiment, the messaging server 130 receives a message sent by a client device 110A via the network 120 and routes the message to client device 110B via the network 120. The received message may include routing metadata. (e.g., a user identifier, a phone number, an email address). The received messages may be encrypted, and the messaging server 130 may at least partially decrypt received messages to determine the message's one or more recipients. The messaging server 130 may push the received message to the client device 110B associated with the routing metadata, or the messaging server may send the received message to client device 110B in response to a device request for received messages. In other embodiments, messages may be sent directly between client devices 110A and 110B in a peer-to-peer configuration without using the messaging server 130 to route the messages.

The messaging server 130 is generally implemented on a computing device (e.g., a server) having at least one processor and a non-transitory, computer-readable storage medium. The at least one processor executes instructions (e.g., computer program code) to perform functionality including message routing. The storage medium may also store messages, which may be deleted after delivery for a threshold time thereafter). The messaging server 130 may include multiple computing devices (e.g., a server farm, a geographically dispersed content delivery network, a cloud-based system).

The network 120 enables communication among the entities connected to it through one or more local-area networks and/or wide-area networks. In one embodiment, the network 120 is the Internet and uses standard wired and/or wireless communications technologies and/or protocols. The network 120 can include links using technologies such as 802.11, worldwide interoperability for microwave access (WiMAX), long term evolution (LTE), or 4G. The data exchanged over the network 120 can be represented using various technologies and/or formats and may be encrypted. Although a single network 120 is illustrated, the network 120 may include multiple networks or sub-networks connecting the entities of the environment 100.

### Example Architecture of Client Device

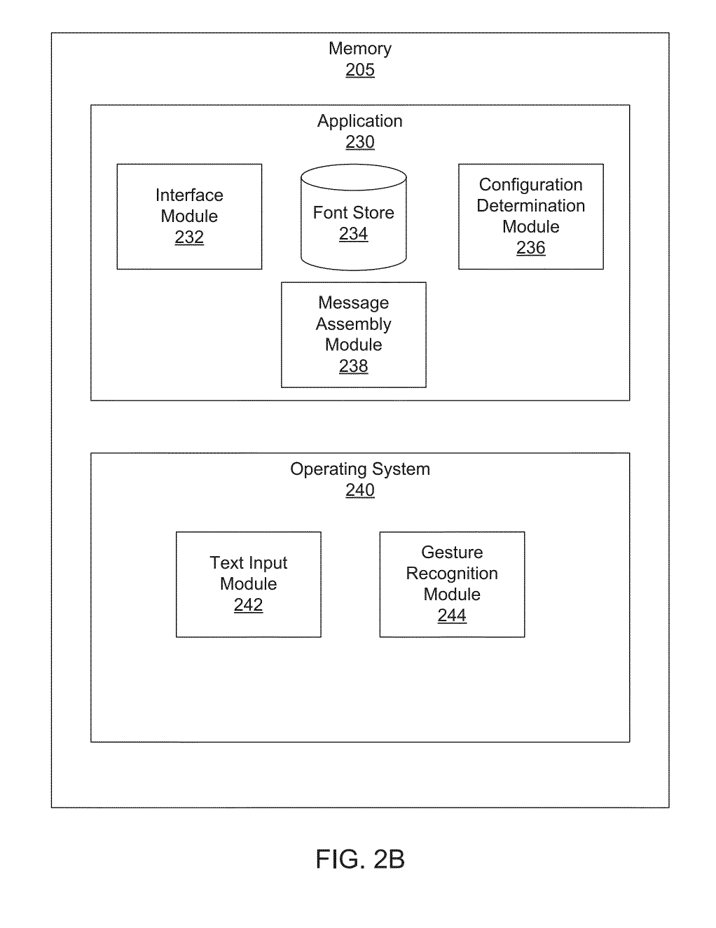

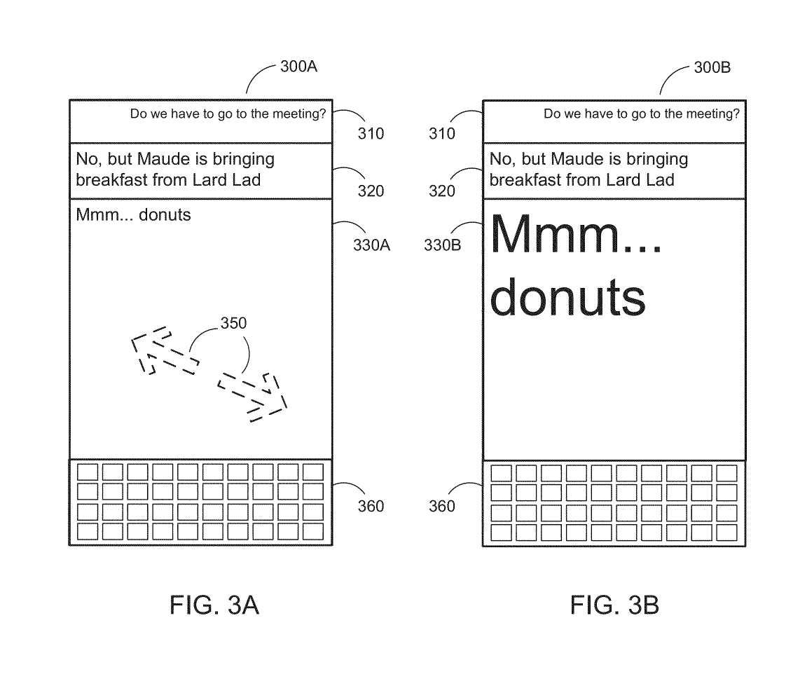

FIG. 2A is a block diagram illustrating components of an example client device 110, according to an embodiment. The example client device 110 may include, among other components, a memory 205, a processor 210, an input device 215, a display device 220, and a network interface device 225. The client device 110 may include other components not illustrated in FIG. 2A such as speakers and sensors.

The memory 205 stores instructions for execution by the processor 210. The memory 205 includes any non-transitory, computer-readable storage media capable of storing instructions. In one embodiment, the instructions include functionality of a messaging application and a device operating system. Example embodiments of memory 205 include semiconductor memory devices (e.g., electrically erasable programmable memory (EEPROM), random access memory (RAM)), flash memory devices, magnetic disks such as internal hard disks and removable discs, and optical discs such as CD-ROM or DVD discs. The instructions stored in the memory 205 are described below in detail with reference to FIG. 2B.

The processor 210 is hardware capable of executing computer instructions. The processor 210 may be coupled to the memory 205, the input device 215, the display device 220, and the network interface device 225. Example processors 210 include a microprocessor, a central processing unit (CPU), a graphic processing unit (GPU), a digital signal processor (DSP), a field-programmable gate array (FPGA), a programmable logic device (PLD), and an application-specific integrated circuit (ASIC). The processor 210 may include one or more cores, or the client device may include multiple processors 210 for concurrent execution of parallel threads of instructions.

The input device 215 enables communication with a user for receiving textual input and formatting inputs. Example input devices 215 include a touchscreen, a keyboard integrated into the client device 110, a microphone for processing voice commands, or a physically separate but communicatively coupled device such as a wireless keyboard, a pointing device such as a mouse, or a motion-sensing device that detects gesticulations. In one embodiment, the input device 215 is a touchscreen capable of sensing example gesture motions including taps, double-taps, pinches or stretches between at least two points of contact, swiping motions (e.g. swipe gesture motions, scroll gesture motions) with one or more points of contact, and rotational motions (i.e. rotation gesture motions) between two or more points of contact.

The display device 220 graphically displays interfaces of the client device 110 for viewing, composing, or sending messages. Example display devices 220 include a screen integrated with client device 110 or a physically separate but communicatively coupled display device (e.g., a monitor, a television, a projector, a head-mounted display). Alternative or additional display devices 215 include other display technologies that may be developed (e.g., holographic displays, tactile displays) or auditory displays (e.g., speakers or headphones that recite a received message). The display device 220 and the input device 215 may be integrated, for example, in a touchscreen.

The network interface device 225 may be hardware, software, firmware, or a combination thereof for connecting the client device 110 to the network 120. Example interface devices 225 include antennas (e.g., for cellular, WiFi, or Bluetooth communication) or ports that interface with a USB (Universal Serial Bus) cable or flash drive, or a HDMI (high-definition multimedia interface) cable as well as circuits coupled to these components for processing signals to be sent or received via these components. The interface device 225 may optionally communicatively couple the client device 110 to a separate input device 215 and/or display device 220.

FIG. 2B is a block diagram illustrating modules of an example application 230 and an example operating system 240 on the memory 205 of the example client device 110, according to an embodiment. The application 230 provides functionality for composing, viewing, and sending messages and includes an interface module 232, a font store 234, a configuration determination module 236, and a message assembly module 238. The application 230 may include additional modules not illustrated (e.g., for handling messages including images, audio, or video; for encrypting and decrypting messages).

The operating system 240 manages resources available on the client device 110. Applications access the resources of the client device 110 through the operating system 240. The operating system 240 may include, among other components, a text input module 242 and a gesture recognition module 244. The operating system 240 may include additional modules not illustrated (e.g., modules for interfacing with an audio output device or a display device 220, modules for low-level tasks such as memory management.

### Composing and Viewing Messages

The text input module 242 recognizes inputs received through the input device 215 and converts the received inputs to textual characters for display by the interface module 232. The conversion of inputs may include mapping signals from the input device 215 to characters (e.g., for a keyboard input device). In one embodiment where the input device 215 is a touch screen, the text input module 242 may include instructions for displaying a virtual keyboard interface. A user may select a region of the virtual keyboard on the touch screen that corresponds to a character to input that character. The text input module 242 resolves the selection of the character and indicates the selected character to the interface module 232. The text input module 242 may interpret inputs that correspond to multiple characters (e.g., using a swipe gesture across a touch screen keyboard to input several characters, where the beginning, end, and corners of the swipe gesture correspond to the input characters). The text input module 242 may provide for other input mechanisms such as speech-to-text processing or transferring text from another source (e.g., a copy-and-paste functionality).

The interface module 232 provides a visual interface for composing messages as well as for viewing sent and received messages. In one embodiment, the interface module 232 displays textual input entered by a user and provides for selection of one or more message recipients. The interface module 232 displays entered text in a composing region of the interface. In the context of a messaging application, the composing region contains unsent text and other message content. More broadly, the interface module 232 displays user interface elements, which include textual input, images (e.g., photos, icons), animations, videos, or any other element displayable through the display device 220. The interface module 232 displays a composing region that contains user interface elements input or modified by a user. The interface module 232 may include a formatting functionality to vary the configuration of user interface elements in the composing region. The configuration of user interface elements includes the size of user interface elements as well as position and orientation of user interface elements. For example, in response to a user input received through the input device 215, the interface module 232 displays a composed, but unsent, message in various configurations at different font sizes (e.g., the text is enlarged or shrunk). As the example text is enlarged or shrunk, the interface module 232 displays the text in various configurations (e.g., small text on a single line, large text on multiple lines). Other configurations of user interface elements change the color of user interface elements (e.g., background color, text color, image tint). The interface module 232 may display a received message with a similar configuration (at least in part) to the configuration (e.g., font size, positioning) applied by an additional client device at the time the additional client device sent the message.

To display text in one embodiment, the interface module 232 receives text from the text input module 242 (for a composed but unsent message) or from a decoded message in the application 230. To display the text as formatted, the interface module 232 receives configuration information and retrieves font data representing one or more fonts from the font store 234. For a received or sent message, the configuration information (e.g., font size) may be decoded from formatting metadata of the message. For text in a composed but unsent message, the font size may be received from the configuration determination module 236. In either case, the interface module 232 may include a default configuration (including a default font size) for use when the user has not selected configuration information such as font size or when the message omits configuration information, for example.

The font store 234 includes a font of the application 230. In one embodiment, the font is stored as a set of instructions for rendering vector graphics depending on a font size and other configuration information. The font store 234 may support a font that supports a wide range of font sizes (e.g., any font size between a lower font size threshold and an upper font size threshold), or the font store 234 may support a discrete number of font sizes. Using application fonts from the font store 234 provides for consistent text display across client devices 110, even devices having different operating systems 240 with varying availability of system fonts. The font store 234 may include a single font for use in displaying and composing messages. Alternatively or additionally, the font store 234 may include multiple fonts selectable by a user through the interface module 232, but a single font advantageously reduces data requirements for transmitted messages because an indication of the message font may be omitted from transmitted message configuration information. A single font also decreases the storage size of the of the application 230 on the memory 205 because the font store 234 contains less data than a font store 234 containing multiple fonts.

### Font Size and Other Configuration Determination

The gesture recognition module 244 recognizes non-textual gesture motions from the input device 215. The interface module 232 may use these gesture motions for interface navigation, and the configuration determination module 236 may use these gesture motions to determine font size. Generally, the gesture recognition module 244 resolves gesture parameters, which the configuration determination module 236 may use to modify the configuration of user interface elements. In one embodiment, the gesture parameters include one or more start positions of a gesture, which may indicate a subset of user interface elements that a gesture may modify. Generally, those user interface elements in the starting region are selected for the subset of modified user interface elements. For example, the start positions of pinch, stretch, swipe, scroll, and rotation gesture motions include the one or more points of contact for the gesture. If these initial points of contact are made in a composing region corresponding to message composition, then the configuration determination module 236 interprets the gesture as modifying the size of message content and other configuration information of the composed message.

In one embodiment, the gesture recognition module 244 recognizes gesture motions made with a gesture object on or substantially close to a gesture-sensing surface (e.g., a touchscreen or other screen, a touch-sensitive whiteboard) that combines the functionality of the input device 215 and the display device 220. A gesture object is an object used to interact with a gesture-sensing surface. Example gesture objects include a finger, a stylus, or another writing implement ent configured to interact with a proximate gesture-sensing surface. The gesture recognition module recognizes gesture motions, which begin with the gesture object contacting the surface at a starting position contained within the displayed composing region. The gesture object then moves across the surface while maintaining contact with the surface. The gesture motion is complete when the gesture object detaches from the surface after moving across the screen. Generally, the gesture motion encompasses a single continuous contact between the surface and one or more gesture objects, which maintain contact within a portion of the surface displaying the composing region. A contact between the surface and the gesture object includes physical contact on or substantially close to the surface.

In one embodiment, the gesture recognition module 244 resolves gesture parameters including a start position and an end position, which are used to determine a modification to the configuration. For swipe or scroll gesture motions, the start position and end position refer to the location of the one or more points of contact at the beginning and end of the gesture, respectively. For pinch and stretch gesture motions, the start position and end position refer to the linear displacement between the points of contact at the beginning and of the gesture, respectively. For rotation gesture motions, the start position and end position refer to the angular displacement between a reference line and a line overlaying the points of contact. Hence, the gesture recognition module 244 provides gesture parameters for use by the configuration determination module 236.

The configuration determination module 236 uses the gesture parameters determined by the gesture recognition module 244 as well as a first configuration (including a first font size) to determine a second configuration including a second font size for user interface elements such as composed text in the interface module 232. The configuration determination module 236 may use the start position of an input to determine whether user interface elements are modified as well as which subset of the user interface elements is modified. For example, if the interface module 232 displays multiple composing regions, the start position indicates which composing region the gesture motion modifies. The configuration determination module 236 recognizes the gesture is intended to modify the configuration of message content in the composing region containing the start position.

If the gesture is intended to modify configuration, then the configuration determination module 236 computes a change magnitude and a change direction between the start position and the end position of the gesture to determine the modified configuration in one embodiment. The change magnitude corresponds to an amount of size modification from the current size (e.g., a default size or the last determined size of the user interface element), and the change direction corresponds to whether the size is increased or decreased from the size of the current configuration. For a pinch or a stretch gesture, the change magnitude is based on the difference between the distances of the start position and end position, and the change direction is based on whether the gesture is a pinch or a stretch. For a rotation gesture, the change magnitude is based on the difference between the angles of the start position and end position, and the change direction is based on the direction of rotation (e.g., clockwise or counter-clockwise). For a swipe gesture or a scroll gesture, the change magnitude is based on the difference between the positions of the start position and the end position, and the change direction is based on the general direction between the positions (e.g., a generally upwards swipe corresponds to increasing the font size relative to the current font size). Hence, the configuration determination module 236 determines configurations including size for the interface module 232 based on a current configuration and the gesture parameters from the gesture recognition module 244.

In one embodiment, the configuration determination module 236 optionally imposes an upper threshold and/or a lower threshold on a determined size. The configuration determination module 236 may modify the determined size to be substantially equal to an upper size threshold if the determined size is greater than the upper size threshold. Similarly, if the determined size is less than a lower size threshold, the configuration determination module 236 may modify the determined size to be substantially equal to the lower size threshold.

The gesture recognition module 244, configuration determination module 236, and interface module 232 may communicate substantially in real time to provide visual feedback for a gesture motion. In other words, as the gesture object moves across the screen while in contact with the screen, a current configuration is updated to match the progression of the gesture object across the screen. For example, in a pinch motion with two fingers (gesture objects), a user shrinks a sentence of text (a subset of user interface elements). As the user carries out the pinch motion in contact with the screen, the size and positioning of the sentence of text (its configuration) updates in proportion to the distance of the pinch from the starting point of contact. Hence, the interface module 232 may display an updated configuration before the gesture object detaches from the surface of the combined display device 220 and input device.

When a user decides to send a message, the message assembly module 238 encodes the message contents and their configuration (determined at least in part by the configuration module 236) into a message. The assembled message may be represented in a standardized format that includes message metadata, message configuration, and message content. Message metadata may include associated times (e.g., sent time, receipt time or data used to route the message such as an indicator of the message protocol or unique identifiers (e.g., of the message sender, of the message recipient, of the message itself). Message configuration includes data used by a recipient's client device 110 to replicate the formatting and display of the message, as displayed by the sender's client device 110. Message configuration may include size, font, number of lines in the message, other text formatting, message background color, text color, tints or other effects applied to images or videos, and relative positions of message contents. Lastly, encoded message contents include the substantive content of the message, such as text, images, videos, audio, or animations. The network interface device 225 transmits the assembled message to the recipient's client device 110.

### Example User Interface

FIG. 3A and FIG. 3B illustrate an example composer interface 300 for manipulating font size in messages exchanged between client devices, according to an embodiment. FIG. 3A illustrates an initial composer interface 300A as created by the interface module 232 before receiving input to modify the size of the font. The composer interface 300A includes a previous message 310 sent by a sending user as well as a previous message 320 received by the sending user, who is in the process of composing a current message 330A, which encompasses a composing region. The contents of the messages 310, 320, and 330A are each a subset of user interface elements. The composer interface 300 also includes a virtual keyboard 360 for inputting a textual input through input device 215. The text input module 242 converts signals from the input device 215 to displayed text. To enlarge the text displayed in the current message 330A, the user makes a stretch gesture 350 with a gesture object. The gesture recognition module 244 recognizes the stretch gesture 350 and determines gesture parameters for the configuration determination module 236.

FIG. 3B illustrates the example composer interface 300B after receiving the stretch gesture. The interface module 232 displays the current message 330B using the font from the font store 234 with a font size as determined by the configuration determination module 236. As part of modifying the configuration of the current message 330B, the number of lines and spatial arrangement of the text is modified in addition to the font size. If a pinch gesture is received instead of the stretch gesture 350, then the determined font size would be decreased from the current font size and the current message 3309 would have smaller text.

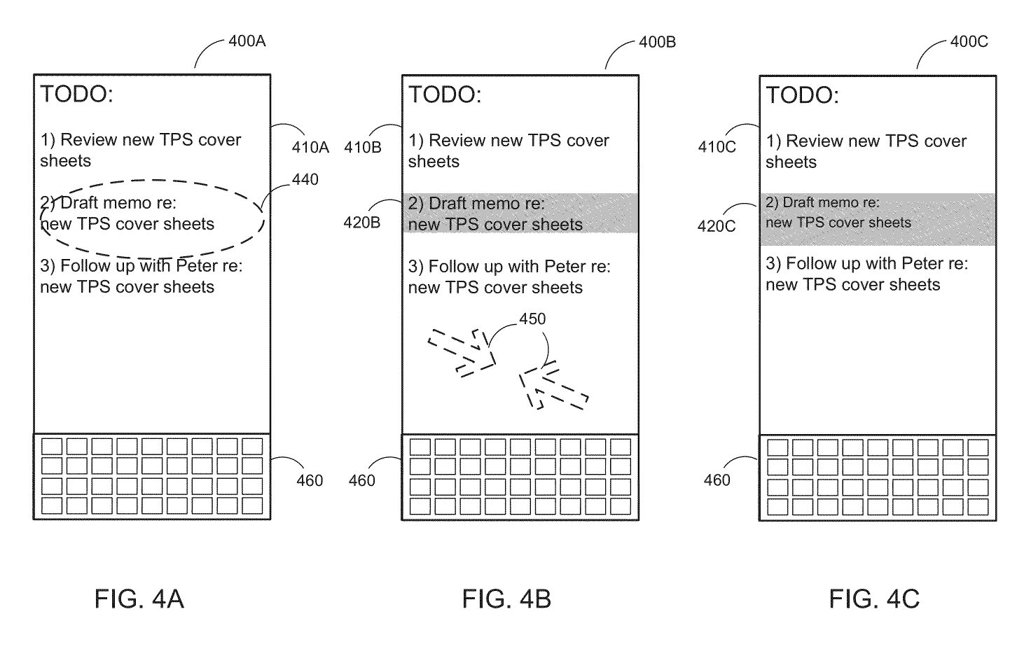

FIG. 4A, FIG. 4B, and FIG. 4C illustrate an alternative method for manipulating font size in an example composer interface 400, according to an embodiment. The composer interface 400 may be used to manipulate the configuration of user interface elements (such as a textual input) outside of a messaging context as in a word processor, for example. The composer interface 400 includes a virtual keyboard 460 for inputting a textual input through the text input module 242. FIG. 4A illustrates an initial composer interface 400A as created by the interface module 232 before selecting a portion of the text for manipulation. The composer interface 400A includes composed text 410A, which encompasses a composing region. As illustrated, the user selects a portion of the text (i.e., a subset of user interface elements) to manipulate the font size of that highlighted portion with a highlighting gesture 440. This additional gesture may be a double tap gesture or a tap and drag gesture, for example.

FIG. 4B illustrates the composer interface 400B after receiving the highlighting gesture 440. The interface module 232 indicates the highlighted text out of the composed text 410B with visual indicator 420B. To manipulate the font size of the highlighted text, the user applies a stretch gesture 450 through the input device 215.

FIG. 4C illustrates the composer interface 400C after receiving the stretch gesture 450. The text in the visual indicator 420C has been reduced in size relative to the remainder of the text. If the user had omitted the highlighting gesture 420B, the stretch gesture 450 would have enlarged all the composed text 410C, in one embodiment. If a stretch gesture replaced the pinching gesture 450, then the text in the visual indicator 420C would be shrunk relative to the rest of the text.

### Process of Manipulating Font Size

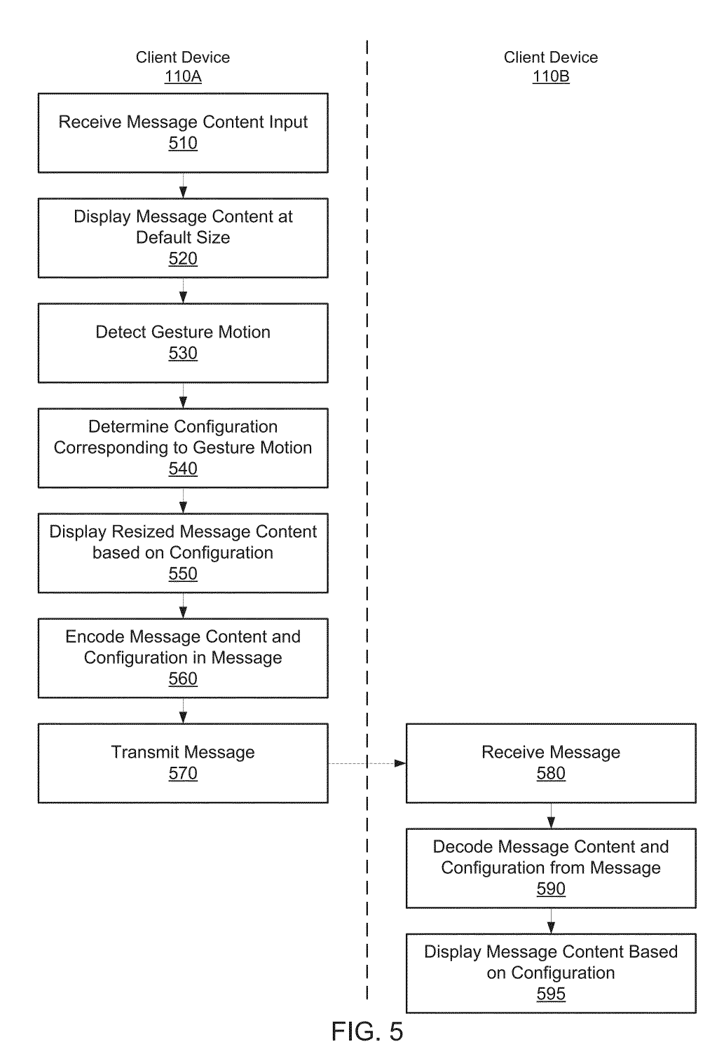

FIG. 5 is a flow chart illustrating an example process for manipulating font size in messages exchanged between client devices 110A and 110B, according to an embodiment. The client device 110A receives 510 message content such as a textual input through the text input module 242. The message content may include any user interface element. The interface module 232 displays 520 the message content based on a current configuration including current size. The gesture recognition module 244 detects 530 a gesture motion to modify a subset of the displayed user interface elements the received message content). The gesture recognition module determines gesture parameters from the path of the gesture motion that contacts the screen in a composing region containing the subset of user interface elements, moves across the screen, and detaches from the screen. The configuration determination module 236 determines 540 an updated configuration including an updated size corresponding to the gesture motion based on the current font size and the gesture parameters. The interface module 232 displays 550 the resized textual input (or other subset of user interface elements) based on the determined configuration.

The application 230 then encodes 560 the message content and its configuration in a message, which the network interface device 225 transmits 570 over network 120 to client device 110B. Client device 110B receives 580 the transmitted message through its network interface device 225. An application 230 of the client device 110B decodes 590 the received message to extract message content and its configuration. The interface generator 232 of client device 110B displays 595 the received message content based on the configuration decoded from the message. Although the client device 110B typically displays user interface elements in the message content at the same size they were composed, the physical size of the displayed content may differ between client devices 110A and 110B depending on their respective screen sizes and resolutions.

In an alternative implementation outside of a messaging context, any interface element may replace the message content, and the example process may end after displaying 550 the updated subset of user interface elements without creating and transmitting a message. For example, the client device 110A waits for additional textual inputs or gesture motions to a composing region to directly manipulate the configuration of displayed user interface elements in the composing region. This alternative implementation includes applications such as word processing, editing portions of electronic doodles, and editing portions of photographs, for example. In this alternative implementation, the client device 110B is optional.

The disclosed embodiments beneficially enable convenient manipulation of the size of user interface element displayed on a client device. Manipulating size of elements in sent messages provides a more nuanced form of communication because users may convey emotions or other subtleties through choice of font size. The process of manipulating a size through multiple gestures (e.g., a drop down menu) deters size manipulation in hastily composed messages. The disclosed embodiments may be implemented without dedicated buttons (or other regions of the display device 215) for manipulating size, which may clutter the user interface on a small display devices 215. Overall, direct size and configuration manipulation enhances the user experience in a messaging or other context that includes text input and manipulation.

While particular embodiments and applications of the present invention have been illustrated and described, it is to be understood that the disclosure is not limited to the precise construction and components disclosed herein. Various modifications, changes and variations may be made in the arrangement, operation and details of the method and apparatus of the present disclosure without departing from the spirit and scope of the disclosure as described herein.

What is claimed is:

1. A method of displaying user interface elements on a screen of a computing device, the method comprising;
displaying the user interface elements including a subset of the user interface elements, the subset of the user interface elements in a first configuration including a first size;
detecting a gesture motion on the screen representing a size change of the subset of the user interface elements, the gesture motion comprising the at least one gesture object:
contacting a composing region of the screen, the composing region containing the subset of user interface elements;
moving across the screen while maintaining the contact with the screen; and
detaching from the screen responsive to moving across the screen; and
displaying the subset of the user interface elements in a second configuration including a second size.

2. The method of claim 1, wherein each of the at least one gesture objects comes into contact with the screen once during the gesture motion.

3. The method of claim 1, further comprising continuously displaying the first subset of the user interface elements in changing configurations in a plurality of sizes between the first size and the second size as the at least one gesture object is moved across the screen while maintaining contact with the screen.

4. The method of claim 1, further comprising receiving a selection of the subset of the user interface elements by detecting an additional gesture motion by the at least one gesture object.

5. The method of claim 4, wherein the additional gesture motion comprises:
contacting, with the at least one gesture object, a first portion of the screen displaying a starting point of the subset of the user interface elements;
moving the at least one gesture object from the first portion of the screen to a second portion of the screen displaying an ending point of the subset of the user interface elements; and
detaching the at least one gesture object from the second portion of the screen.

6. The method of claim 1, wherein the at least one gesture object is a pair of fingers, and wherein the performed gesture motion is selected from a group consisting of: a pinch gesture, a stretch gesture, a swipe gesture, and a scroll gesture.

7. The method of claim 1, further comprising:
encoding the subset of the user interface elements and the second size into a message; and
transmitting the message including the encoded user interface elements and the second size to an additional computing device configured to display the subset of the user interface elements based on the second size.

8. The method of claim 1, wherein the detected gesture motion is applied to a region of the screen displaying the subset of the user interface elements.

9. A non-transitory computer-readable storage medium comprising instructions for displaying user interface elements on a screen of a computing device, the instructions when executed by a processor cause the processor to:
display the user interface elements including a subset of the user interface elements, the subset of the user interface elements in a first configuration including a first size;
detect a gesture motion on the screen representing a size change of the subset of the user interface elements, the gesture motion comprising the at least one gesture object:
contacting a composing region of the screen, the composing region containing the subset of user interface elements;
moving across the screen while maintaining the contact with the screen; and
detaching from the screen responsive to moving across the screen; and
display the subset of the user interface elements in a second configuration including a second size.

10. The storage medium of claim 9, wherein each of the at least one gesture objects comes into contact with the screen once during the gesture motion.

11. The storage medium of claim 9, wherein the instructions further comprise instructions to cause continuous displaying of the first subset of the user interface elements in changing configurations in a plurality of sizes between the first size and the second size as the at least one gesture object is moved across the screen while maintaining contact with the screen.

12. The storage medium of claim 9, wherein the instructions further cause the processor to receive a selection of the subset of the user interface elements by detecting an additional gesture motion.

13. The storage medium of claim 12, wherein the additional gesture motion comprises:
contacting, with the at least one gesture object, a first portion of the screen displaying a starting point of the subset of the user interface elements;
moving the at least one gesture object from the first portion of the screen to a second portion of the screen displaying an ending point of the subset of the user interface elements; and
detaching the at least one gesture object from the second portion of the screen.

14. The storage medium of claim 9, wherein the at least one gesture object is a pair of fingers, and wherein the performed gesture motion is selected from a group consisting of: a pinch gesture, a stretch gesture, a swipe gesture, and a scroll gesture.

15. The storage medium of claim 9, wherein the instructions causing the processor to:
encode the subset of the user interface elements and the second size into a message; and
transmit the message including the encoded user interface elements and the second size to an additional computing device configured to display the subset of the user interface elements based on the second size.

16. The storage medium of claim 9, wherein the detected gesture motion is applied to a region of the screen displaying the subset of the user interface elements.

17. A system for manipulating font size in a composer interface, the system comprising:
a processor;
a screen configured to detect gesture motions and display user interface elements;
an interface module causing the screen to:
display user interface elements including a subset of the user interface elements, the subset of the user interface elements in a first configuration including a first size, and
display the subset of the user interface elements in a second configuration including a second size; and
a gesture recognition module configured to detect a gesture motion on the screen representing a size change of the subset of the user interface elements to the second size, the gesture motion comprising the at least one gesture object:
contacting a composing region of the screen, the composing region containing the subset of user interface elements,
moving across the screen while maintaining the contact with the screen, and
detaching from the screen responsive to moving across the screen.

18. The system of claim 17, wherein each of the at least one gesture object comes into contact with the screen once during the gesture motion.

19. The system of claim 17, wherein the interface module further causes the screen to display the first subset of the user interface elements in changing configurations in a plurality of sizes between the first size and the second size as the at least one gesture object is moved across the screen while maintaining contact with the screen.

20. The system of claim 17, further comprising:
a message assembly module configured to encode the subset of the user interface elements and the second size into a message; and
a network interface device configured to transmit the message including the encoded user interface elements and the second size to another computing device to display the subset of the user interface elements in the second size.
